(19) United States
(12) Patent Application Publication
(10) Pub. No.: US 2009/0117410 A1
(43) Pub. Date: May 7, 2009

(54) Thin Film Material and Recording Medium

(75) Inventors: Akiyoshi Itoh, Chiba (JP); Katsuji Nakagawa, Tokyo (JP); Arata Tsukamoto, Chiba (JP)

Correspondence Address: K&L Gates LLP, P.O. Box 1135, CHICAGO, IL, 60690, US

(73) Assignee: NIHON UNIVERSITY, Tokyo (JP)

(21) Appl. No.: 10/599,665

(22) PCT Filed: Feb. 25, 2005
(86) PCT No.: PCT/JP2005/003655

§ 371 Date: Nov. 3, 2006

(30) Foreign Application Priority Data
Feb. 25, 2004 (JP) 2004-050366

(51) Int. Cl. G11B 5/74; B32B 9/04; B32B 3/26

(52) U.S. Cl. 428/837; 428/448; 428/314.2

(57) ABSTRACT

Disclosed is a thin film material including a substrate (10) and an underlying layer (11) formed on the substrate. A large number of recesses of an extremely small size are demonstrated in a surface of the underlying layer (11). On this surface of the underlying layer is formed a magnetic film (12) or a non-magnetic film (12).

### TECHNICAL FIELD

This invention relates to a thin film material capable of forming a film of a regular structure, and to a recording medium capable of forming fine recording marks.

The present application claims the priority rights based on the Japanese Patent Application 2004-50366, filed in Japan on Feb. 25, 2004. The contents of this earlier Application is to be included by reference into the present Application.

### BACKGROUND ART

In a thin film material, manufactured in these days, a film(s) of variegated properties are layered on a substrate to exploit the properties of the film(s). For example, in a recording medium, a magnetic film or a non-magnetic film is layered on a substrate.

In the case of a recording medium, including a magnetic film on a substrate, chances for handling the information of a large data volume are increasing, even in household use, due to the remarkable progress made in the field of the IT industries in recent years. In keeping up with this tendency, a demand is raised for increasing the recording capacity of the recording medium, and a large variety of techniques have so far been proposed.

There is, for example, a method of reducing the size of the recording marks, formed on a recording medium, for raising the recording capacity of the recording medium in an in-plane direction. Stringent competitions are now going on with a goal of achieving an ultra-high recording density of 100 Gbit/inch² to 1 Tbit/inch².

Meanwhile, in case the recording mark size is progressively miniaturized, in keeping up with the increasing recording density, there is presented a problem that the recording marks cease to exist under the thermal fluctuation phenomenon.

Thus, a low noise non-crystalline magnetic material, exhibiting high perpendicular magnetic anisotropy, such as TbFeCo, is now in use, as a magnetic material for forming fine recording marks, with a view to forming recording marks in stability.

However, if, with TbFeCo, neighboring recording marks (domains) are magnetized in different directions, the domain boundary (magnetic wall) is changed continuously. Thus, with miniaturization of the size of the recording mark (domain), the contracting force of the wall is increased, thus raising a problem that fine recording marks become destabilized to cause the loss of the recording marks.

### DISCLOSURE OF THE INVENTION

It is an object of the present invention to provide a recording medium in which, with the use of a low noise non-crystalline magnetic material, exhibiting high perpendicular magnetic anisotropy, such as TbFeCo, the recording marks are not lost under the force of wall contraction, even if fine recording marks are formed.

The present invention provides a thin film material including a substrate, an underlying layer in which a large number of recesses of an extremely small size are uniformly demonstrated in the substrate, and a preset film of a regular structure derived from the recesses demonstrated in the underlying layer. The preset film is formed on the underlying layer.

The present invention also provides a recording medium including a substrate, an underlying layer in which a large number of recesses of an extremely small size are uniformly demonstrated, and a magnetic film or a non-magnetic film formed on the surface of the underlying layer in which the recesses of the extremely small size are demonstrated. The underlying layer is formed on the substrate

The present invention also provides a recording medium including a substrate, an underlying layer in which a large number of recesses of an extremely small size are uniformly demonstrated, a first magnetic film or a first non-magnetic film formed on the surface of the underlying layer in which the recesses of an extremely small size are demonstrated, and a second magnetic film or a second non-magnetic film formed on the first magnetic film or the first nonmagnetic film. The underlying layer is formed on the substrate. The second magnetic film or the second non-magnetic film is of properties different from those of the first magnetic film or the first non-magnetic film.

### BRIEF DESCRIPTION OF THE DRAWINGS

FIG. 1 is a cross-sectional view showing the structure of a thin film material according to the present invention.

FIG. 2 is a schematic view showing the structure of a spherically-shaped micelle.

FIG. 3 is a cross-sectional view showing a first example of the constitution of a recording medium according to the present invention.

FIG. 4 is a cross-sectional view showing an underlying layer of the recording medium shown in FIG. 3 and the vicinity of the boundary of a magnetic film formed on the underlying layer.

FIG. 5 is a graph showing magnetization curves of inventive and control recording mediums.

FIG. 6 is a diagram showing magnetic wall coercivity Hw, magnetic wall coercivity ratio Hw/Hc and saturation magnetization Ms of an inventive recording medium and the control medium.

FIG. 7 is a cross-sectional view showing a second example of the constitution of a recording medium according to the present invention.

FIG. 8 is a cross-sectional view showing a third example of the constitution of a recording medium according to the present invention.

FIG. 9 is a cross-sectional view showing the constitution of an underlying layer prepared using an F68 triblock copolymer.

FIG. 10 is a top plan view showing the constitution of an underlying layer formed using an F88 triblock copolymer.

FIG. 11 is a photo showing the constitutions before and after formation of a film of a magnetic material on the underlying layer formed using an F88 triblock copolymer.

### BEST MODE FOR CARRYING OUT THE INVENTION

Referring to the drawings, a preferred embodiment of the present invention will be described in detail.

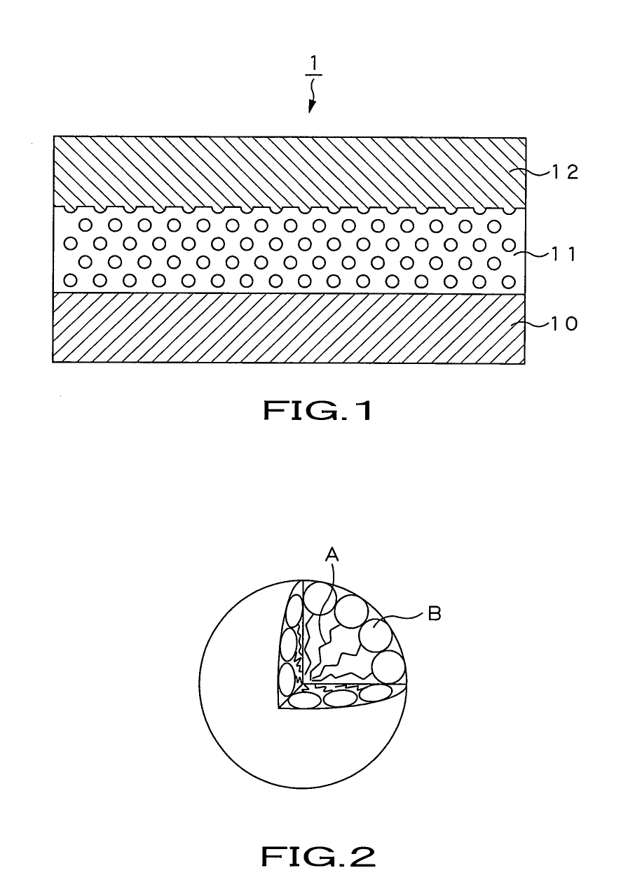

The present invention is applied to, for example, a thin film material 1 having a constitution shown for example in FIG. 1. The thin film material 1 includes a substrate 10, an underlying layer 11, formed thereon, and in which a large number of fine recesses are evenly represented, and a film 12, formed on the underlying layer, and which is of an orderly structure derived from the recesses represented in the underlying layer 11.

The substrate 10 is a Si substrate, as an example, and the underlying layer 11 is formed of silicon oxide and a mixture thereof. In the underlying layer 11, there are evenly formed a large number of voids in a predetermined cubic configuration, for example, a face-centered cubic lattice configuration. The surface of the underlying layer 11, on which the predetermined film of the orderly structure is to be formed, is subjected to surface processing so that a large number of evenly formed fine recesses will be represented thereon.

The method for forming the underlying layer 11 will now be described.

Initially, a reaction solution is formulated. The reaction solution is obtained on adding 22 ml of ethanol and 6.4 ml of tetraethoxysilane or TEOS (Si(C₂H₅O)₄)), with the purity of 98%, to 4.7 ml of pure water (pH, 1.4), which has been mixed with hydrogen hydrochloride (HCl). To the so generated reaction solution, 0.008 mol of a triblock copolymer, as a substance compatible with two mediums, is mixed, and the resulting mixture is agitated at ambient temperature. Although F68 (EO₇₇-PO₂₉-EO₇₇) or F108 (EO₁₃₃-PO₅₀-EO₁₃₃) is used as a triblock copolymer, in the present embodiment, any other suitable triblock copolymer may also be used. Meanwhile, EO and PO denote ethylene oxide and propylene oxide, respectively, and the suffix numbers denote the numbers of monomers.

When the triblock copolymer is mixed into the reaction solution, and the resulting mass is agitated, spherically-shaped micelles, composed of the triblock copolymer, shown in FIG. 2, are generated in the reaction solution. This spherically-shaped micelle is formed by a plural number of triblock copolymers. The spherically-shaped micelle includes a hydrophobic group A in its inside, and a hydrophilic groups B on its outer side. In the present embodiment, the spherically-shaped micelle is formed from the triblock copolymer. However, it is only sufficient that voids are formed within the underlying layer 11, as will be explained subsequently, such that the shape of the micelle, formed of the triblock copolymer, is not limited to the spherical shape.

A thin-film layer is then formed, using a reaction solution containing the plural spherically-shaped micelles as described above. The thin-film layer is formed by spin coating, under the condition of the rotational speed of 5000 rpm and a rotation time duration of 30 seconds, for example.

The reaction solution, formed into a thin film by spin coating, is dried at ambient temperature to form a thin film layer of SiO₂ containing the spherically-shaped micelles. The thin film layer of SiO₂ is formed of tetraethoxy silane as a feedstock material. The thin film layer of SiO₂ is formed by the spherically-shaped micelles which are self-arrayed in a face-centered cubic lattice configuration.

The operation of removing the spherically-shaped micelles from the thin film layer of SiO₂ is then carried out. This operation of removing the spherically-shaped micelles is carried out by annealing, with the annealing time duration of one hour and the annealing temperature of 400° C. By this annealing operation, the spherically-shaped micelles are removed, with the sites formerly occupied by the spherically-shaped micelles becoming voids. Consequently, the thin film layer of SiO₂ now is a porous SiO₂ layer, in which the voids are formed uniformly in the face-centered cubic lattice configuration

The porous layer of SiO₂ is formed not by the physical technique, such as FIB (focused ion beam) technique, but by a chemical method for synthesis.

The surface processing for the porous layer of SiO₂ will now be described. The surface of the porous layer of SiO₂, formed as described above, that is, the surface on which to form the film comprised of an orderly structure, is etched so that fine recesses will be formed evenly therein. Meanwhile, it is sufficient that, by the etching, the fine recesses are formed evenly on the surface of the porous SiO₂ layer. The etching may be carried out with e.g. Ar ions.

The size of the voids is determined by the size of the spherically-shaped micelles, that is, the sort of the triblock copolymer, and may be as small as approximately several nm or tens of nm. In the present embodiment, the case of using a triblock copolymer, with the void size being approximately 5 and approximately 8 nm, will be described.

Thus, with the thin film material 1, according to the present invention, the preset film of an orderly structure, derived from the fine recesses, evenly represented in the underlying layer 11, is formed on the underlying layer 11. Consequently, the above preset film of an arbitrary structure may be formed on the underlying layer 11, by changing the size of the recesses, represented in the underlying layer 11, to an arbitrary size, or by changing the interval between neighboring recesses to an arbitrary interval. Meanwhile, the film formed on the underlying layer 11 may be a film of Co, Fe, CoPd, CoPt, TbFeCo or GdFeCo, or a film of isolated FePt nano fine particles of an L1₀ structure exhibiting high anisotropy (Ku).

The thin film material 1 according to the present invention, described above, may be used for a wide variety of mediums. Meanwhile, in the following explanation, the same reference numerals are used to depict the same components as those of the thin film material 1 and detailed explanation is dispensed with.

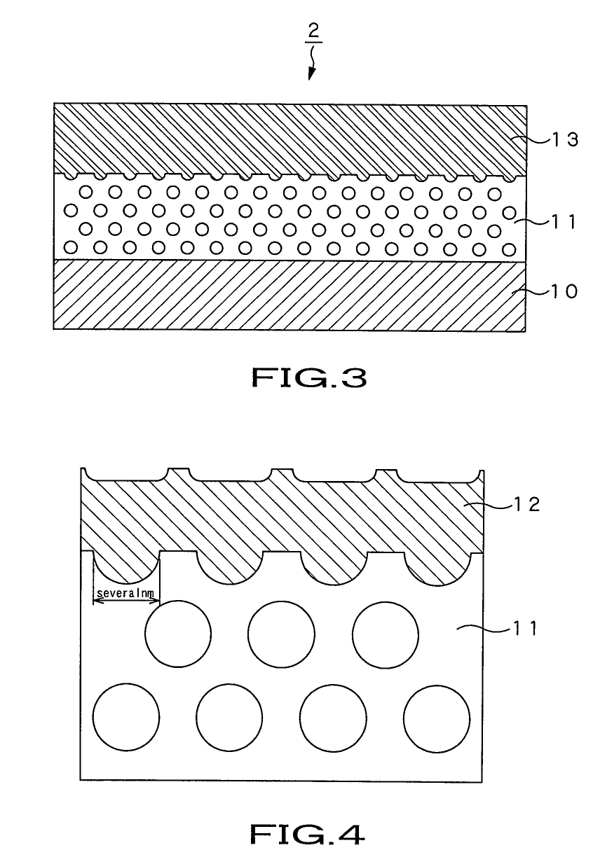

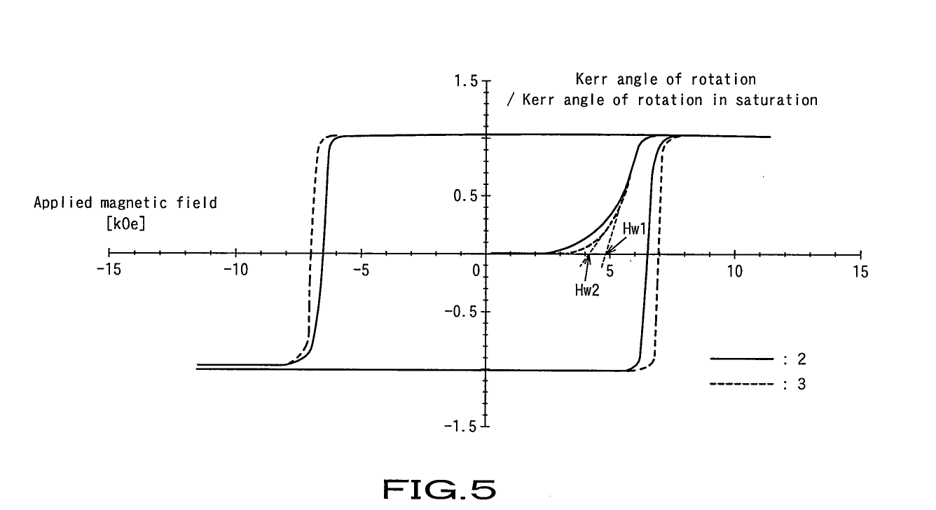

For example, the thin film material 1 according to the present invention may be applied to a recording medium 2 of the structure shown in FIG. 3. The recording medium 2 includes an underlying layer 11 and a magnetic film 13, arranged in this order on a substrate 10. The underlying layer 11 at least has fine uniform recesses represented thereon, and the magnetic film 13 exhibits magnetic anisotropy and has recording magnetic domains (recording marks) formed thereon. FIG. 4 depicts an enlarged cross-sectional view showing the magnetic film 13 being formed on the underlying layer 11 representing the evenly spaced fine recesses.

The relationship between the increase in the magnetic wall energy (force of wall contraction), brought about by the miniaturization of recording marks, formed on the magnetic film 13, and the magnetic coercivity Hw resisting the increase in the wall energy, will now be described.

When the recording mark (recording magnetic domain) formed on the magnetic film 13 is miniaturized in size, the wall energy (force of wall contraction) will become dominant, and hence the recording mark is collapsed by the wall and thus ceases to exist. It is therefore necessary that the wall coercivity Hw shall be larger than the force of wall contraction.

The wall coercivity Hw will now be described. When the magnetic wall is being moved in a magnetic substance, the energy potential becomes irregular as a result of defects, changes in shape or distortion in the magnetic film 13 or nonuniform distribution of magnetic anisotropy. The wall coercivity Hw means the strength of the magnetic field needed for the wall to be moved against this energy potential.

If a planar magnetic wall is presupposed within the perpendicularly magnetized film, the film thickness is h and the wall energy density Hw is changing along the x-direction, the wall coercivity Hw is expressed by the following equation (1).

$$Hw = \frac{{σ}_{w}}{2 Ms} \frac{\partial ( {σ}_{w} h )}{\partial x} {\vert}_{max} = \frac{{σ}_{w}}{2 Ms} \{ \frac{1}{2} ( \frac{1}{Ku} \frac{\partial Ku}{\partial x} + \frac{1}{A} \frac{\partial A}{\partial x} ) + \frac{1}{h} \frac{\partial h}{\partial x} \} {\vert}_{max} \qquad ( 1 )$$

It is seen from the equation (1) that, for increasing the wall coercivity Hw, it is sufficient to increase the locality-limited variations of the film thickness h, energy of magnetic anisotropy Ku and the exchange stiffness constant A. Meanwhile, the above equation (1) indicates the maximum value of the wall coercivity Hw for a magnetic material.

According to the present invention, it is necessary to increase the wall coercivity Hw so as to be larger than the wall contracting force. To this end, the magnetic film 13 is layered on the underlying layer 11, in which the fine recesses are uniformly represented, and the film thickness h, represented by the equation (1), is varied to increase the wall coercivity Hw.

Meanwhile, the underlying layer 11 is formed so that recesses smaller than the size of the recording marks will be represented for effectively pinning the recording marks formed on the magnetic film 13.

For the magnetic film 13, a low noise non-crystalline magnetic material, exhibiting high magnetic anisotropy, such as TbFeCo, is used. The proportions of the component elements of TbFeCo, used in the present invention, are set so that Tb:Fe:Co=18:70:12.

Since the magnetic film 13 is non-crystalline, the domain boundary (wall) is continuously changed in case neighboring domains (recording marks) are magnetized in different directions.

The magnetic film 13 may be formed of a material other than TbFeCo, such as an amorphous material, for example, GdFeCo, or a monocrystalline material, such as CoPd, CoPt or FePt.

Ideally, the process steps for manufacturing the recording medium 2 are carried out in their entirety in one manufacturing apparatus without exposing the component materials to outside air. However, after etching the underlying layer 11 so that fine recesses are uniformly demonstrated therein, it may become necessary to take out the underlying layer 11 from the etching unit and to transport the underlying layer 11 to a separate unit for depositing the magnetic film 13 thereon. For such case, it is more desirable to provide means for removing the foreign matter, affixed during the transport on the surface of the underlying layer 11, before proceeding to deposit the magnetic film 13. Such means for removing the foreign matter may be such means for generating the plasma with which to remove the foreign matter from the substrate surface.

The present inventors have conducted evaluations on the magnetic properties of the recording medium 2 according to the present invention. The changes in magnetization against changes in the magnetic field applied to the recording medium 2 will now be described along with the results of the evaluation. The magnetic properties were evaluated using a vibrating sample magnetometer (VSM), with the maximum applied magnetic field of 13 kOe, and a Kerr effect measurement unit, with the maximum applied magnetic field of 13 kOe. For evaluating the magnetic properties, the recording medium 2 is of a structure composed of the underlying layer 11, deposited on the substrate 10, the magnetic film 13, deposited on the underlying layer 11, and SiN deposited on the magnetic film 13. A control medium is of a structure devoid of the underlying layer 11, that is, a structure in which a magnetic film is deposited on a substrate and SiN is deposited on the magnetic film.

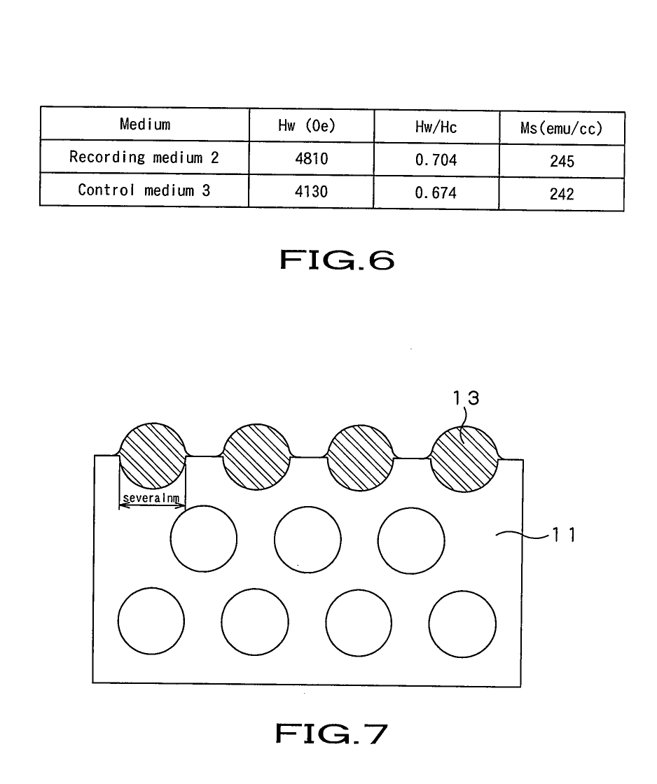

FIG. 5 shows magnetization curves of the recording medium 2 and the control medium 3 (magnetic Kerr effect hysteresis loop) and FIG. 6 shows wall coercivity Hw, the ratio of the wall coercivity Hw to coercivity Hc, or Hw/Hc, and saturation magnetization Ms, in the inventive and control mediums. The value of the ratio Hw/Hc as close to unity (1) as possible, that is, the ratio for which Hw=Hc, represents an ideal value.

With the recording medium 2, the wall coercivity Hw is 4810 Oe (Hw1 in FIG. 5), with the ratio Hw/Hc being 0.704, as shown in FIG. 6. With the control medium 3, the wall coercivity Hw is 4130 Oe (Hw2 in FIG. 5), with the ratio Hw/Hc being 0.674, as again shown in FIG. 6.

Hence, the recording medium 2 of the present invention is higher than the control medium in both the wall coercivity Hw and the ratio Hw/Hc.

That is, with the recording medium 2 of the present invention, the magnetic film 13 is formed on the underlying layer 11 in which the fine recesses are uniformly demonstrated, so that the wall coercivity Hw is increased. Consequently, when a domain (recording mark) of an extremely small size has been formed in the magnetic film 13, the pinning point for the domain boundary (wall) is formed under the effect of the recess demonstrated in the underlying layer 11. Hence, the recording mark is not lost under the force of wall contraction, with the result that recording marks of an extremely small size may be formed in high stability. Meanwhile, the locations of the pinning points are determined by the film thickness h, energy of magnetic anisotropy Ku and the exchange stiffness constant A indicated in the above equation (1).

The recording medium 2 according to the present invention may be used as a magnetic recording medium and a magnetooptical recording medium in which fine recording marks of the nano-order size are formed.

In the above-described embodiment, the recording medium 2 is of a structure in which the magnetic film 13 has been laminated on the underlying layer 11 in its entirety. Alternatively, the magnetic film 13 may be layered so as to fill in the recesses demonstrated in the surface of the underlying layer 11 to form protuberances thereon as shown in FIG. 7. At this time, the magnetic film is layered so that the protuberances are discrete with respect to one another. Meanwhile, in case the recording medium 2 is configured as shown in FIG. 7, it may be exploited as a patterned medium including larger numbers of recording marks of an extremely small size (nm size).

The recording medium 2 may also be configured such that a non-magnetic film formed of a dyestuff based material or a material for phase change recording is layered on the underlying layer 11 in which there are demonstrated larger numbers of recesses of an extremely small size. This recording medium 2 may be exploited as an optical recording medium in which there are formed larger numbers of recesses of an extremely small size (nanometer size).

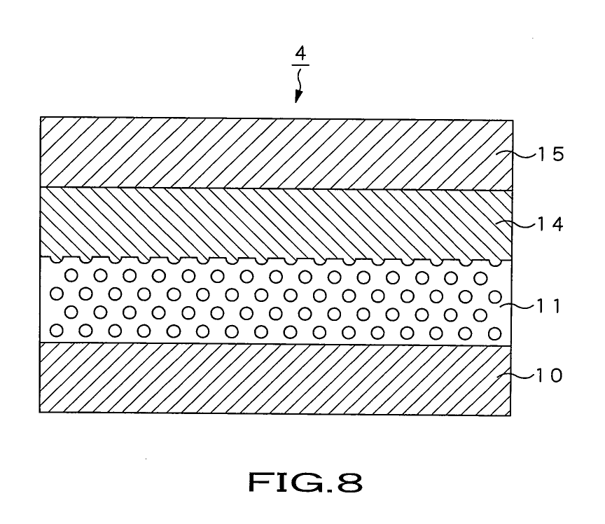

The thin film material 1 of the present invention may also be exploited for a recording medium 4 configured as shown in FIG. 8. The same reference numerals are used to depict the same components of the recording medium 4 as those of the recording medium 2 described above and the corresponding explanation is dispensed with.

Referring to FIG. 8, there are layered, on a substrate 10 of the recording medium 4, an underlying layer 11, a first film 14 and a second film 15 having the properties different from those of the first film 14. In the underlying layer 11, there are uniformly demonstrated larger numbers of recesses of an extremely small size. In the recording medium 4, the first film 14 operates as a functional film with respect to the second film 15.

The first film 14 and the second film 15 may be magnetic films formed of an amorphous material, such as TbFeCo or GdFeCo, or magnetic films formed of a monocrystalline material, such as CoPd, CoPt or FePt. The first and second films may also be non-magnetic films formed of a dyestuffbased material or a material for phase change recording.

With the recording medium 4, the first film 14 is layered on the entire underlying layer 11, whilst the second film 15 is formed on the first film 14. In the first film 14, there are formed at this time the portions affected by the recesses formed in subjacent zones and the portions not affected by the recesses. Since the second film 15 is layered on top of the first film 14, there are generated significant non-uniformities in the second film 15 under the effect of the first film 14. In case the first film 14 and the second film 15 are both magnetic films, these films 14, 15 become a composite film, resulting from exchange coupling, and hence are increased in coercivity Hc and in wall coercivity Hw.

That is, with the recording medium 4, in which the first film 14 is layered on the underlying layer 11, in which larger numbers of recesses of an extremely small size are demonstrated, and the second film 15 is layered on the first film 14, significant non-uniformities may be generated in the second film 15. Hence, the recording medium 4 may be exploited as a composite recording film.

With the recording medium 4, the first film 14 may be formed so that protuberances will be formed in the recesses, uniformly demonstrated in the underlying layer 11, and the second film 15 may be layered on top of the first film.

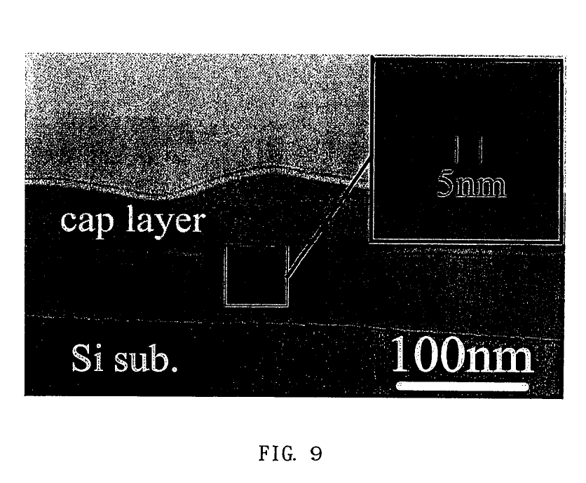

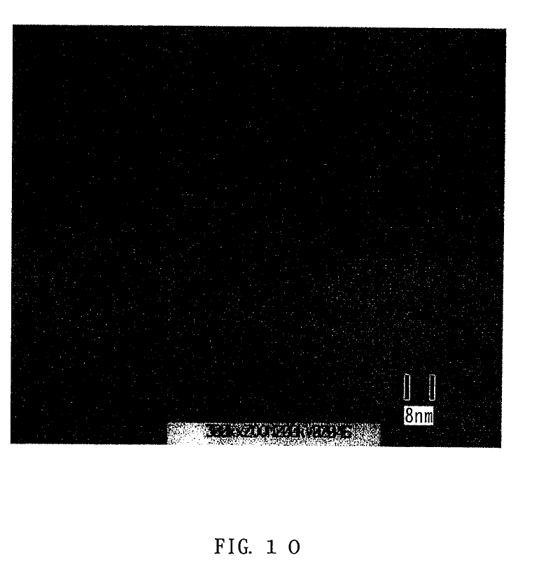

FIG. 9 shows an embodiment of the underlying layer 11, formed using an F68 triblock copolymer. FIG. 10 shows an embodiment of the underlying layer 11, formed using an F88 triblock copolymer. In case the F68 triblock copolymer is used, the void size is approximately 5 nm, whereas, in case the F88 triblock copolymer is used, the void size is approximately 8 nm. Thus, the void size may be modified (enlarged) by increasing the number of molecules of the high molecular material. Meanwhile, FIG. 9 is a photo by TEM (Transmission Electron Microscope) of the cross-section of the underlying layer 11, obtained with the use of the F68 triblock copolymer, and FIG. 10 is a photo by TEM of the state in the in-plane direction of the underlying layer 11, obtained with the use of the F88 triblock copolymer.

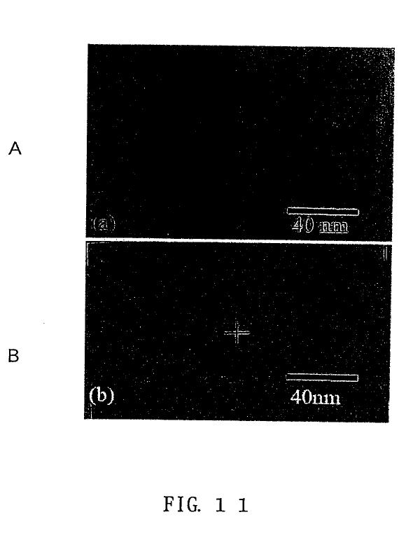

FIG. 11A is a photo by TEM of the surface of underlying layer 11, obtained with the use of the F88 triblock copolymer, in which voids have been generated by sputter etching. FIG. 11B is a photo by TEM of the surface of underlying layer 11, obtained with the use of the F88 triblock copolymer, in which a magnetic material (Co atoms) has been formed by a sputtering method on the surface of the underlying layer to a thickness of approximately five atoms. In the surface of the underlying layer, there are demonstrated voids by sputter etching.

It is seen from FIG. 11B that Co atoms may be formed as a cluster in accordance with the periodicity of the voids formed in the surface of the underlying layer 11.

With the recording medium 4 according to the present invention, in which numerous recesses of an extremely small size (nm size) may be arrayed in a regular pattern on the underlying layer 11, the photonic band gap, which is a sort of the quantum optical effect, may be formed. Hence, the present invention may be applied to photonic crystals.

The present invention is not limited to the above embodiments, so far explained in detail with reference to the drawings. It will be appreciated by those skilled in the art that various changes or substitution by equivalent means may be attempted without departing from the scope and the purport of the invention as defined in the appended claims.

### INDUSTRIAL APPLICABILITY

With the thin film material of the present invention, described above in detail, a preset film of a regular structure, derived from the recesses of an extremely small size, demonstrated in an underlying layer, is formed on the underlying layer. Hence, a film of an optional structure may be formed on the underlying layer, as the size of the recess, demonstrated in the underlying layer, is changed to an optional size or as the interval between the neighboring recesses is changed to an optional interval.

Moreover, with the recording medium according to the present invention, in which the magnetic layer is laminated on the underlying layer in which a large number of recesses are uniformly demonstrated, the magnetic wall coercivity Hw is increased. In case magnetic domains of an extremely small size (recording marks) are formed on the magnetic film, the pinning points for the domain boundary (wall) are formed under the influence of the recesses demonstrated in the underlying layer. Hence, the recording marks are not lost under the force of wall contraction, so that recording marks of an extremely small size may be generated in stability.

1. A thin film material comprising a substrate;
an underlying layer in which a large number of recesses of an extremely small size are demonstrated uniformly in an substrate; and
a preset film of a regular structure derived from said recesses demonstrated in said underlying layer; said preset film being formed on said underlying layer.

2. The thin film material according to claim 1 wherein said underlying layer is composed of silicon oxide and a mixture thereof, and includes a large number of voids evenly formed to a preset cubic structure, and wherein said underlying layer is surface-processed so that a large number of recesses of extremely small sizes are uniformly demonstrated in a surface thereof on which said preset film of the regular structure is formed.

3. The thin film material according to claim 2 wherein said underlying layer is a layer which is composed of silicon oxide and a mixture thereof and in which a large number of spherically shaped voids of the same size, with the diameter of the voids being several nm to tens of nm, are uniformly formed to a face-centered cubic structure.

4. A recording medium comprising a substrate;
an underlying layer in which a large number of recesses of an extremely small size are uniformly demonstrated, said underlying layer being formed on said substrate; and
a magnetic film or a non-magnetic film formed on the surface of said underlying layer in which said recesses of the extremely small size are demonstrated.

5. The recording medium according to claim 4 wherein said magnetic film or the non-magnetic film is layered on the recesses demonstrated in said underlying layer to form protuberances which are discrete with respect to one another.

6. The recording medium according to claim 4 wherein said magnetic film or the non-magnetic film is layered on the entire surface of said underlying layer.

7. The recording medium according to claim 4 wherein said underlying layer is a layer which is formed of silicon oxide and a mixture thereof and in which a large number of voids are formed uniformly to a preset cubic structure, and wherein the surface of said underlying layer on which said magnetic layer or the non-magnetic layer is deposited has been processed so that the recesses are demonstrated uniformly.

8. The recording medium according to claim 7 wherein said underlying layer is a layer which is formed of silicon oxide and a mixture thereof and in which a large number of spherically-shaped voids of the same size, with the diameter of several nm to tens of nm, are formed uniformly to a face-centered cubic structure.

9. A recording medium comprising a substrate;
an underlying layer in which a large number of recesses of an extremely small size are uniformly demonstrated, said underlying layer being formed on said substrate;
a first magnetic film or a first non-magnetic film formed on the surface of said underlying layer in which said recesses of an extremely small size are demonstrated; and
a second magnetic film or a second non-magnetic film formed on said first magnetic film or said first non-magnetic film; said second magnetic film or the second non-magnetic film being of properties different from those of said first magnetic film or said first non-magnetic film.

10. The recording medium according to claim 9 wherein
said first magnetic film or said first non-magnetic film is layered on said recesses demonstrated in said underlying layer to form protuberances which are discrete with respect to one another, and wherein
said second magnetic film or the second non-magnetic film is formed in said discrete protuberances, formed by said first magnetic film or said first non-magnetic film which is formed on said underlying layer.

11. The recording medium according to claim 9 wherein
said first magnetic film or the first non-magnetic film is layered on the entire surface of said underlying layer, and wherein
said second magnetic film or the second non-magnetic film is formed on said first magnetic film or said first non-magnetic film.

12. The recording medium according to claim 9 wherein said underlying layer is composed of silicon oxide and a mixture thereof, and includes a large number of voids evenly formed to a preset cubic structure, and wherein the surface of said underlying layer on which is formed said first magnetic film or the first non-magnetic film is processed so that a large number of recesses of an extremely small size are demonstrated in said surface.

13. The recording medium according to claim 12 wherein said underlying layer is a layer which is formed of silicon oxide and a mixture thereof and in which a large number of spherically-shaped voids of the same size, with the diameter of several nm to tens of nm, are formed uniformly to a face-centered cubic structure.
